(19) United States
(12) Patent Application Publication
(10) Pub. No.: US 2014/0023459 A1
(43) Pub. Date: Jan. 23, 2014

(54) SNAP RING

(71) Applicant: GM Global Technology Operations LLC, Detroit, MI (US)

(72) Inventor: Ezzat S. Ayad, Commerce Township, MI (US)

(21) Appl. No.: 13/897,997

(22) Filed: May 20, 2013

Related U.S. Application Data
(60) Provisional application No. 61/674,642, filed on Jul. 23, 2012.

(51) Int. Cl. F16B 21/18

(52) U.S. Cl. CPC F16B 21/186
USPC 411/517

(57) ABSTRACT

The present invention provides a retainer ring for axially retaining a first member with respect to a second member. The retainer ring includes a plurality of substantially linear segments disposed about the first member. The retainer ring further includes a break or opening that facilitates positioned the retainer ring about the first member.

### CROSS-REFERENCE TO RELATED APPLICATIONS

This nonprovisional application claims the benefit of U.S. Provisional Application No. 61/674,642, filed Jul. 23, 2012, the entire contents of which are incorporated herein by reference.

### FIELD

The present disclosure relates to a snap ring. More specifically, the present disclosure relates to a snap ring for use with motor vehicle axles.

### BACKGROUND

The statements in this section merely provide background information related to the present disclosure and may or may not constitute prior art.

A retainer ring or snap ring is typically a substantially circular or annular retaining device having a break or opening which divides the ring into two interconnected curvilinear members. The members may be deflected or flexed to facilitate insertion into a mating groove. Snap-rings are constructed to direct a retaining or clamping force along the circumference or periphery of the snap-clip when properly inserted onto a component. Specifically, the directional force is most commonly used to retain or clamp together various mating components.

There are generally two styles of snap-rings: an internal snap-ring employed for applying outwardly-directed clamping force, and an outer snap-ring positioned for applying inwardly-directed clamping force. Of these two types of snap-rings, internal snap-rings are of particular beneficial use within an automatic vehicle transmission.

### SUMMARY

The present invention provides a retainer ring for axially retaining a first member with respect to a second member. The retainer ring includes a plurality of substantially linear segments positioned about the first member. The retainer ring further includes a break or opening that facilitates positioned the retainer ring about the first member.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 shows a retainer ring positioned about a shaft in accordance with the principles of the present invention;

FIG. 2 shows a conventional retainer ring;

FIG. 3 shows a retainer ring in accordance with the principles of the present invention; and

FIGS. 4A, 4B and 4C and FIGS. 5A, 5B and 5C show a comparison of the performance between the conventional retainer ring of FIG. 2 and the retainer ring of FIG. 3.

### DETAILED DESCRIPTION

The following description is merely exemplary in nature and is not intended to limit the present disclosure, application, or uses.

Referring now to the drawings, a snap ring or retainer ring embodying the principles of the present invention is designated at 10 in FIG. 1. The retainer ring 10 includes four substantially linear segments 14 of about the same length and two shorter linear segments 16 of about the same length. One end of each segment 16 is connected to an adjacent segment 14 while the other ends of the segments 16 define a break or opening to facilitate placement of the retainer ring 10 about a mechanical component such as a shaft 12. As such, the retainer ring 10 provides a connection between an axle such as the shaft 12 and a transmission associated with a motor vehicle.

Referring now to FIG. 3, there is shown another retainer ring 100 in accordance with the principles of the present invention. The retainer ring 100 has a hexagonal shape with five substantially linear segments 22 of about the same length and two shorter substantially linear segments 24 of about the same length, each connected at one end to an adjacent linear segment 22. The segments 22 and 24 have a substantially circular cross sectional shape with a diameter of t₂. Note, that the segments 22 and 24 can have non-circular cross sectional shapes. The non-connected ends of the segments 24 define a break or opening 26 to allow placement of the retainer ring 100 about a component such as an axle or shaft.

The segments 24 and 26 may deflected or flexed to facilitate insertion into a component with, for example, a mating groove. The retainer ring 100 is formed, stamped, or otherwise constructed from a relatively thin layer of metal, such as, for example, stainless steel, which directs a retaining or clamping force along the circumference or periphery of the component. The directional force is most commonly used to retain or clamp together various mating components associated with a motor vehicle transmission.

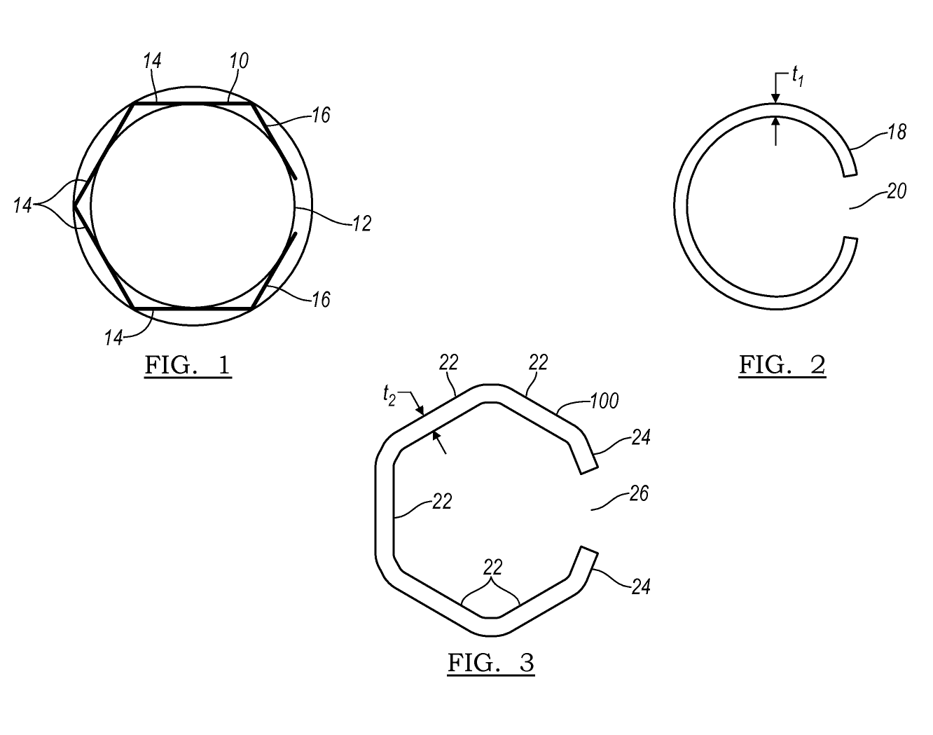

For the sake of comparison FIG. 2 shows a conventional retainer ring 18. The retainer ring 18 is typically a substantially circular or annular retaining device having a break or opening 20 which divides the ring 18 into two interconnected curvilinear members. These members have a cross sectional diameter t₁ and may be deflected or flexed to facilitate insertion into, for example, a mating groove of a component such as an axle.

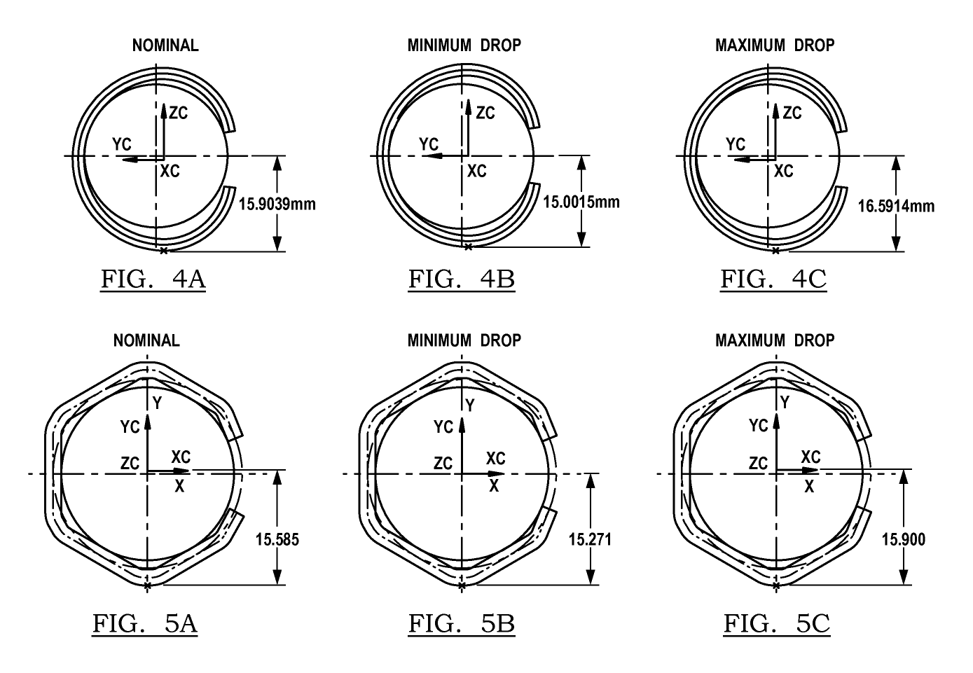

FIGS. 4A, 4B and 4C and FIGS. 5A, 5B and 5C illustrate the benefit of using the retainer ring 100 (FIGS. 5A, 5B and 5C) over the conventional retainer ring (FIG. 4A, 4B and 4C) when either are employed with a shaft with a diameter of about 12 mm.

Specifically, FIGS. 4A, 4B and 4C show that the minimum drop (FIG. 4B) is about 6% less than the nominal drop (FIG. 4A) for the conventional retainer ring, and the maximum drop (FIG. 4C) is about 4% greater than the nominal drop for the conventional retainer ring.

On the other hand, FIGS. 5A, 5B and 5C show that the minimum drop (FIG. 5B) is about 2% less than the nominal drop (FIG. 5A) for the hexagonal shaped retainer ring, and the maximum drop (FIG. 5C) is about 2% greater than the nominal drop for the hexagonal retainer ring. Among other benefits provided by the retainer ring 100, the reduction in drop or droop enables avoidance of damaging the axle seal lip, which is made from a rubber material, during the assembly process. Also note, that the retainer ring 100 is also scalable to fit different shaft diameters, for example, three to four shaft diameters.

The description of the invention is merely exemplary in nature and variations that do not depart from the gist of the invention are intended to be within the scope of the invention. Such variations are not to be regarded as a departure from the spirit and scope of the invention.

What is claimed is:

1. A snap ring for axially retaining a first member with respect to a second member comprising:
a plurality of segments configured to be disposed about one of the first and the second members,
wherein two of the segments of the plurality of segments each have non-connected ends that define an opening to facilitate placement of the snap ring about one of the first and the second members

2. The snap ring of claim 1 wherein each of the plurality of segments has a substantially circular cross sectional shape.

3. The snap ring of claim 1 wherein each of the plurality of segments has a substantially non-circular cross sectional shape.

4. The snap ring of claim 1 wherein each of the segments of the plurality of segments is a substantially linear segment.

5. The snap ring of claim 1 wherein the number of segments of the plurality of segments is 6.

6. The snap ring of claim 5 wherein 4 of the 6 segments are about the same length.

7. The snap ring of claim 6 wherein the other two segments are shorter segments of about the same length.

8. The snap ring of claim 7 wherein each of the two shorter segments has a respective non-connected end.

9. The snap ring of claim 1 wherein the number of segments of the plurality of segments is 7.

10. The snap ring of claim 9 wherein 5 of the 7 segments are about the same length.

11. The snap ring of claim 10 wherein the other two segments are shorter segments of about the same length.

12. The snap ring of claim 9 wherein each of the two shorter segments has a respective non-connected end.

13. The snap ring of claim 1 wherein a minimum drop of the snap ring is about 2% less than a nominal drop of the snap ring.

14. The snap ring of claim 1 wherein a maximum drop of the snap ring is about 2% greater than a nominal drop of the snap ring.

16. The snap ring of claim 1 wherein the snap ring is formed.

17. The snap ring of claim 1 wherein the snap ring is stamped.

18. The snap ring of claim 1 wherein the snap ring is made of a metal.

19. The snap ring of claim 18 wherein the metal is stainless steel.
